(19) United States
(12) Patent Application Publication
(10) Pub. No.: US 2015/0351207 A1
(43) Pub. Date: Dec. 3, 2015

(54) ELECTROSTATIC DISCHARGE MITGATION IN DISPLAY DEVICES

(71) Applicant: QUALCOMM MEMS Technologies, Inc., San Diego, CA (US)

(72) Inventors: Ming-Hau Tung, San Francisco, CA (US); Nassim Khonsari, Redwood City, CA (US); Edward Keat Leem Chan, San Diego, CA (US); Ion Bita, San Jose, CA (US); William J. Cummings, Clinton, WA (US); Alan G. Lewis, Sunnyvale, CA (US)

(73) Assignee: QUALCOMM MEMS Technologies, Inc., San Diego, CA (US)

(21) Appl. No.: 14/290,771

(22) Filed: May 29, 2014

(51) Int. Cl. H05F 1/02; G09G 3/34

(52) U.S. Cl. CPC H05F 1/02; G09G 3/3466; G09G 2300/04; G09G 2320/02

(57) ABSTRACT

This disclosure provides apparatus and methods for mitigating electrostatic discharge (ESD) in display devices. In one aspect, a display device includes an encapsulation substrates having an anti-static coating on one or more of surfaces of the encapsulation substrate. The display devices can include transparent substrates having display elements thereon such that the encapsulation substrate that covers the display elements. The anti-static coating on one or more surfaces of the encapsulation substrate can dissipate charge that may build up during fabrication or operation of the display device. The anti-static coating can be conductive and transparent, with examples of such coatings including transparent conducting oxides (TCOs), thin metal films, thin carbon films, and networks of conductive nanostructures.

### TECHNICAL FIELD

This disclosure relates to display devices, and more particularly to electrostatic discharge mitigation in display devices.

### DESCRIPTION OF THE RELATED TECHNOLOGY

Electromechanical systems (EMS) include devices having electrical and mechanical elements, actuators, transducers, sensors, optical components such as minors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

### SUMMARY

The systems, methods and devices of this disclosure each have several innovative aspects, no single one of which is solely responsible for the desirable attributes disclosed herein.

One innovative aspect of the subject matter described in this disclosure can be implemented in a display device including an encapsulation substrate, a conductive anti-static coating on the encapsulation substrate, a transparent substrate sealed to the encapsulation substrate by a seal, and one or more display elements sealed between the transparent substrate and the encapsulation substrate. The one or more display elements can be configured to generate an image viewable through the transparent substrate. The encapsulation substrate may have a first side and a second side, with the first side facing the display elements. In some implementations, the conductive anti-static coating is disposed between the seal and the encapsulation substrate. In some implementations, the seal is an epoxy seal.

In some implementations, the conductive anti-static coating includes at least one of a transparent conducting oxide, a network of conductive nanostructures, a metal thin film, and a carbon-based thin film. In some implementations, the conductive anti-static coating is semi-transparent or transparent.

In some implementations, the display elements and the encapsulation substrate are spaced-apart by a gas or vacuum gap. In some implementations, the display elements are electromechanical systems (EMS) display elements. For example, the display elements may be interferometric modulator (IMOD) display elements.

In some implementations, the first side of the encapsulation substrate can include a recessed portion to accommodate the display elements and a peripheral portion that is sealed to the transparent substrate. The conductive anti-static coating may be on one or more of the peripheral portion and the recessed portion of the first side of the encapsulation substrate. In some implementations, the conductive anti-static coating is continuous across the peripheral portion and the recessed portion of the first side of the encapsulation substrate. In some implementations, the conductive anti-static coating includes conductive topographic features.

Another innovative aspect of the subject matter described in this disclosure can be implemented in a display device including an encapsulation substrate, a transparent substrate sealed to the encapsulation substrate by a seal, one or more display elements sealed between the transparent substrate and the encapsulation substrate and configured to generate an image viewable through the transparent substrate, and a conductive anti-static coating on the encapsulation substrate, the conductive anti-static coating facing the display elements and including a plurality of conductive topographic features. In some implementations, the conductive topographic features may have a height of at least 5 nm. In some implementations, the conductive topographic features may have a height of at least 20 nm. In some implementations, the conductive anti-static coating includes at least one of a transparent conducting oxide and a network of conductive nanostructures.

Another innovative aspect of the subject matter described in this disclosure can be implemented in a method of manufacturing a display device. The method can include coating one or more surfaces of an encapsulation substrate with a conductive anti-static coating and forming a sealant material on the encapsulation substrate including forming a sealant material on the conductive anti-static coating.

In some implementations, a first side of the encapsulation substrate includes a recessed portion and a peripheral portion that surrounds the recessed portion. Coating the one or more surfaces of the encapsulation substrates can includes conformally coating the first side of the encapsulation substrate. In some implementations, the method can include sealing the encapsulation substrate to a transparent substrate having one or more display elements disposed thereon such that the one or more display elements are encapsulated by the encapsulation substrate.

Another innovative aspect of the subject matter described in this disclosure can be implemented in a display device including a transparent substrate having display elements thereon, an encapsulation substrate sealed to the transparent substrate, thereby encapsulating the display elements and means for dissipating electrostatic discharge. In some implementations, the means for dissipating electrostatic discharge include means for reducing stiction in the display device.

Details of one or more implementations of the subject matter described in this disclosure are set forth in the accompanying drawings and the description below. Although the examples provided in this disclosure are primarily described in terms of EMS and MEMS-based displays, the concepts provided herein may apply to other types of displays such as liquid crystal displays, organic light-emitting diode (OLED) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIGS. 3A and 3B are schematic exploded partial perspective views of a portion of an electromechanical systems (EMS) package including an array of EMS elements and a backplate.

FIG. 4 shows an example of a cross-sectional schematic diagram illustrating a display device including a conductive anti-static coating.

FIGS. 5A-5G show examples of cross-sectional schematic diagrams illustrating arrangements of conductive anti-static coatings on encapsulation substrates.

FIG. 6 shows an example of a flow diagram illustrating a manufacturing process for an encapsulation substrate having a conductive anti-static coating.

FIG. 7 shows an example of a flow diagram illustrating a manufacturing process for a display device having an encapsulation substrate including a conductive anti-static coating.

FIGS. 8A and 8B show examples of schematic diagrams illustrating certain stages of manufacturing a display device having an encapsulation substrate including a conductive anti-static coating.

FIGS. 9A and 9B show examples of schematic diagrams illustrating a response of a display device to a mechanical shock.

FIGS. 9C and 9D show examples of schematic diagrams illustrating conductive anti-static films including topographic features.

FIGS. 10A and 10B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Implementations described herein relate to display devices that include anti-static coatings. The anti-static coatings can mitigate damage due to electrostatic discharge (ESD). A display device can include a transparent substrate having display elements thereon and an encapsulation substrate that covers the display elements. An anti-static coating on one or more surfaces of the encapsulation substrate can prevent or dissipate charge that may build up during fabrication or operation of the display device. The anti-static coating can be conductive and transparent, with examples of such coatings including transparent conducting oxides (TCOs), thin metal films, thin carbon films, and networks of conductive nanostructures.

In some implementations, a conductive anti-static coating can be coated on a peripheral area of the encapsulation substrate on which an epoxy or other sealing material is disposed. The conductive anti-static coating can be disposed between the encapsulation substrate and the sealing material. In some implementations, a conductive anti-static coating on an encapsulation substrate faces display elements disposed on a display glass or other transparent substrate. In some implementations, a conductive anti-static coating on an encapsulation substrate can include topographic features that reduce stiction.

Particular implementations of the subject matter described in this disclosure can be implemented to realize one or more of the following potential advantages. An anti-static coating on an encapsulation substrate of a display device can improve yield and lifetime, reducing failure due to ESD events during fabrication or operation of the display device. An anti-static coating on an encapsulation substrate can mitigate damage to thin film transistors (TFTs) and other electrical components on a display glass or other transparent substrate during processes such as scribe and break and other back end of line (BEOL) processes. An anti-static coating on an encapsulation substrate can mitigate damage due to ESD between display elements of the display device and the encapsulation substrate that may occur during operation of the display device. An anti-static coating including topographic features can reduce contact between the display elements and the encapsulation substrate, mitigating damage due to such contact.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

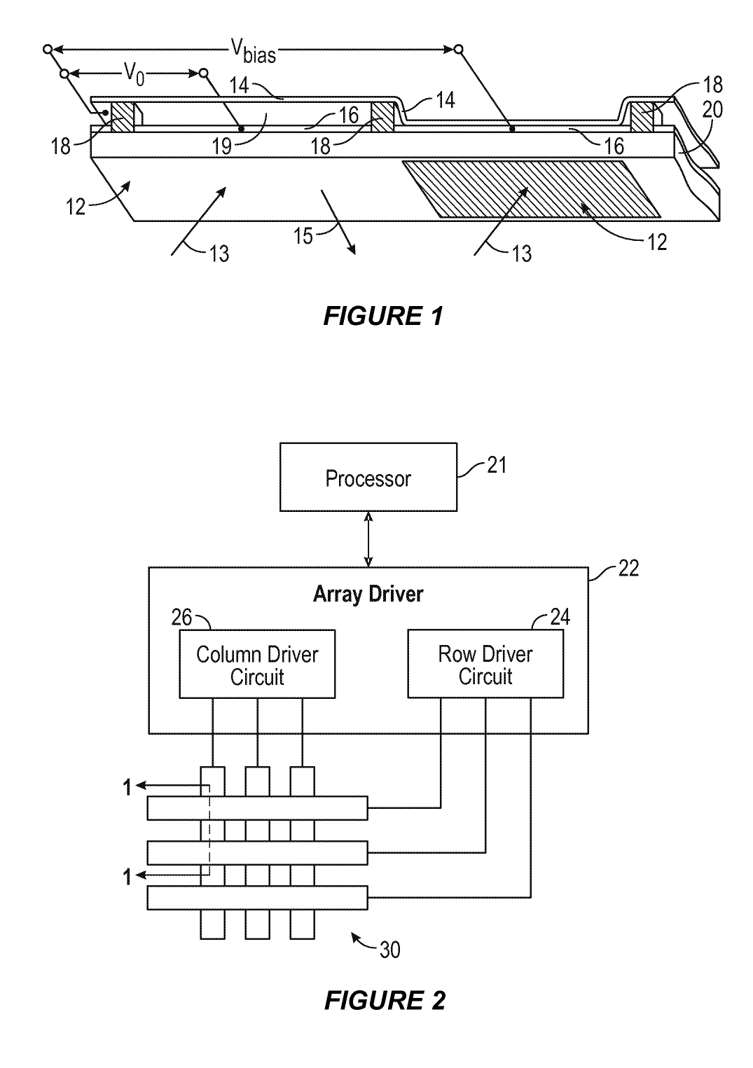

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

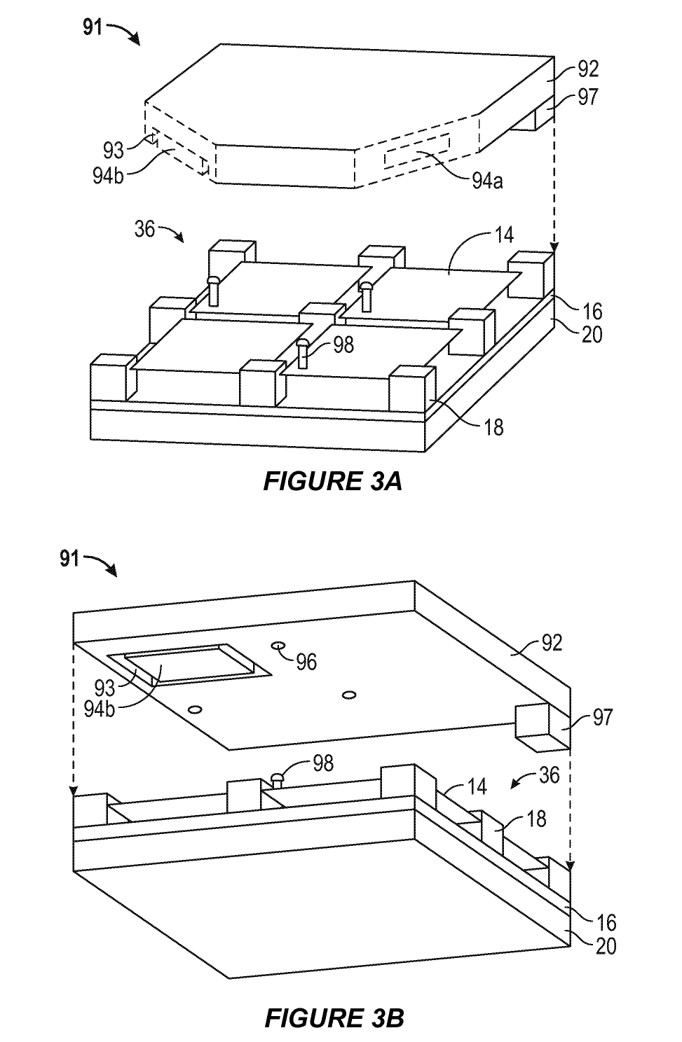

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3x3 array of IMOD display elements for the sake of clarity, the display array 30 may contain a very large number of IMOD display elements, and may have a different number of IMOD display elements in rows than in columns, and vice versa.

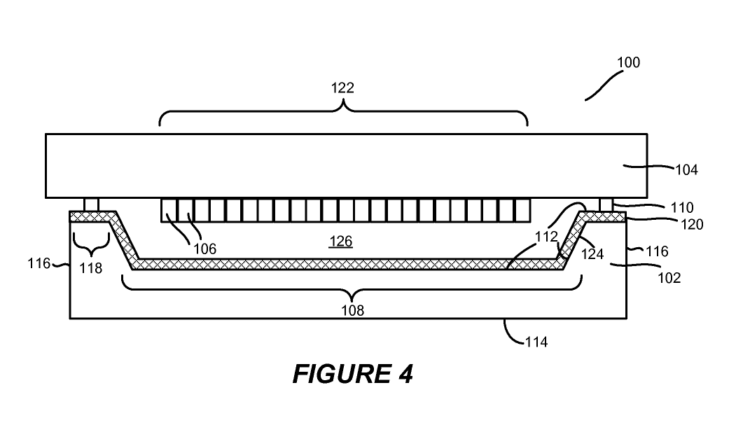

FIGS. 3A and 3B are schematic exploded partial perspective views of a portion of an EMS package 91 including an array 36 of EMS elements and a backplate 92. FIG. 3A is shown with two corners of the backplate 92 cut away to better illustrate certain portions of the backplate 92, while FIG. 3B is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (e.g., the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 3A and 3B, the backplate 92 can include one or more backplate components 94a and 94b, which can be partially or wholly embedded in the backplate 92. As can be seen in FIG. 3A, backplate component 94a is embedded in the backplate 92. As can be seen in FIGS. 3A and 3B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 3B includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 3A and 3B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 3A and 3B, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

Electrostatic discharge (ESD) in a display device can cause failure of the device. For example, ESD during fabrication or operation of a display device can cause failure of an IMOD or other display element. One aspect of the disclosure is a display device including an encapsulation substrate sealed to a transparent substrate, one or more display elements sealed between the display device and encapsulation substrate, and a conductive anti-static coating on at least a portion of the encapsulation substrate. According to various implementations, the anti-static coating may do one or both of preventing static charge from building up and dissipating static charge that may build up during fabrication or operation of the display device.

In some implementations, the display device includes a gap or cavity between the display elements and the encapsulation substrate. Such a gap may be filled with air or another gas composition or be a vacuum cavity. IMOD displays, for example, can include air gaps between the IMOD pixels and the back glass. In some implementations, the display elements may contact the encapsulation substrate or the area between the display elements and the encapsulation substrate may be filled with solid or liquid materials. For example, a cover glass of an organic light emitting diode (OLED) or liquid crystal display (LCD) display device may contact an electrode or other layer of the optical stack. While the examples given below focus on display devices having air gaps, the encapsulation substrates disclosed herein may be implemented in other display devices, such as in OLED and LCD display devices. Further, the encapsulation substrates disclosed herein may be implemented in non-display devices. For example, the encapsulation substrates including conductive anti-static coatings disclosed herein may be implemented in non-display EMS devices.

For display devices, the conductive anti-static coatings disclosed herein are generally on encapsulation substrates that are opposite the display glass or other transparent substrate through which the display is viewed. The display devices may have active-matrix or passive-matrix displays. In some implementations, the encapsulation substrates may be useful for active-matrix displays by mitigating ESD damage to thin film transistors (TFTs) of such display devices.

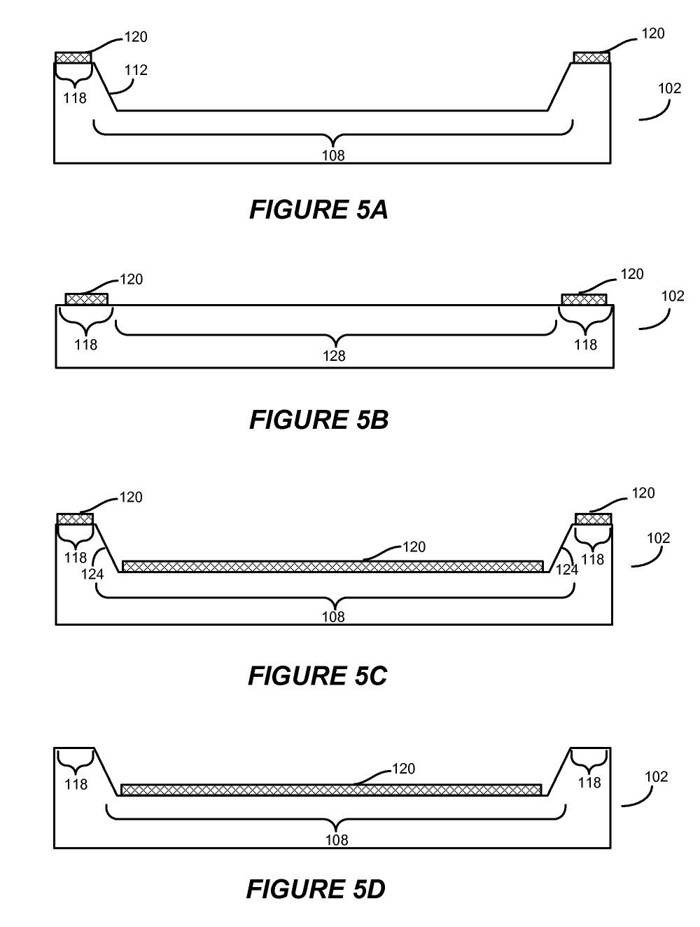

FIG. 4 shows an example of a cross-sectional diagram illustrating a display device including a conductive anti-static coating. The display device 100 includes an encapsulation substrate 102 and a transparent substrate 104. The encapsulation substrate 102 may also be characterized according to various implementations as an encapsulation glass, a back glass, a recess glass or a backplate. The transparent substrate 104 may be characterized according to various implementations as a display glass or a process glass. Display elements 106 are disposed on the transparent substrate 104. The display elements 106 may be fabricated on the transparent substrate 104 in some implementations. Also in some implementations, the display elements 106 are configured to generate an image that can be viewed through the transparent substrate 104. The display elements can be EMS display elements, such as the IMOD display elements 12 depicted in FIG. 1, in some implementations. In some implementations, the display elements can be organic light-emitting diode (OLED) display elements, and the like. Also, in some implementations, TFTs may be electrically connected to the display elements for active-matrix control of the display.

The transparent substrate 104 may be, for example, a transparent substrate 20 as described above with respect to FIG. 1, with examples including glass substrates and non-glass polymeric substrates. The encapsulation substrate 102 may be, for example, a backplate 92 as described above with respect to FIGS. 3A and 3B. According to various implementations, the encapsulation substrate 102 may be transparent or opaque, and may be conductive or insulating. Suitable materials for the encapsulation substrate 102 include, but are not limited to, glass, plastic, ceramics, polymers and laminates. In some implementations, the encapsulation substrate 102 has one or more contoured surfaces; for example, the encapsulation substrate 102 shown in FIG. 4 includes a recess 108 that accommodates the display elements 106, facing an active display area 122 of the display device. In some other implementations, the encapsulation substrate 102 can be essentially planar.

The encapsulation substrate 102 is sealed to the transparent substrate 104 by a seal 110 that contacts the transparent substrate 104 outside of the active display area 122. The seal may be any appropriate seal, including an epoxy seal, a metal seal, or a glass frit. In some implementations, the seal may include PIB, polyurethane, liquid spin-on glass, solder, polymers, plastics, or other materials.

The encapsulation substrate 102 has a front side 112, a back side 114, and sidewalls 116. The front side 112, which includes the recess 108 and a peripheral area 118 that surrounds the recess 108, faces the side of the transparent substrate 104 on which the display elements 106 are disposed and is coated with a conductive anti-static coating 120. In some implementations, the conductive anti-static coating 120 is transparent to facilitate alignment of the encapsulation substrate 102 and the transparent substrate 104. The conductive anti-static coating 120 may be an appropriate conductive material, including transparent conductive oxides, metal thin films, conductive carbon nanotube networks, and the like. Further examples of conductive anti-static coatings are described below. In the example of FIG. 4, the conductive anti-static coating conformally coats the front side 112 such that it is continuous across the front side 112 including across the peripheral area 118, the graded sidewalls 124 of the recess 108 and the planar portion of the recess 108. As discussed further below, conformal coatings including coatings across graded or curved walls of a recess may facilitate charge dissipation in some implementations.

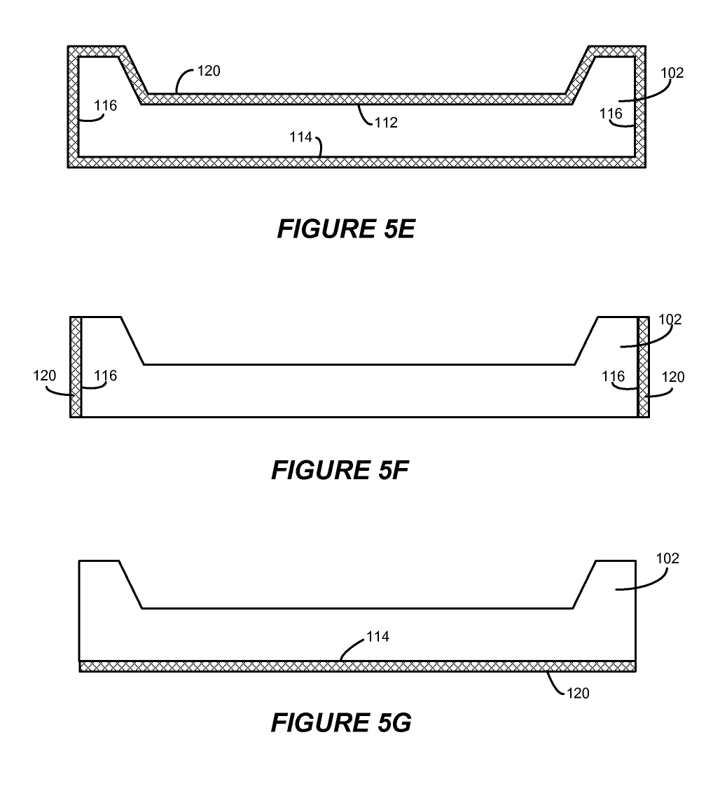

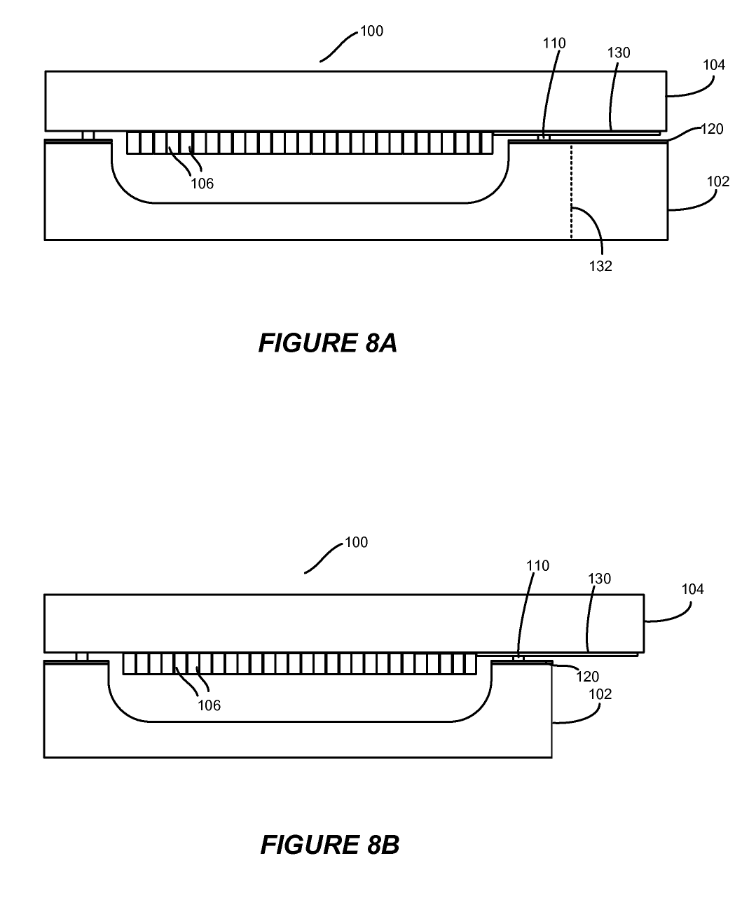

FIGS. 5A-5G show examples of cross-sectional schematic diagrams illustrating arrangements of conductive anti-static coatings on encapsulation substrates. In FIG. 5A, a front side 112 of an encapsulation substrate 102 includes a recess 108 and a peripheral area 118. A conductive anti-static coating 120 is on the peripheral area 118 and not in the recess 108. A similar arrangement is shown in FIG. 5B, with an encapsulation substrate 102 being planar. The encapsulation substrate 102 does not include a recess, but has an area 128 configured to cover display elements on a transparent substrate of a display device. An arrangement as in the examples of FIGS. 5A and 5B may be used to mitigate damage due to ESD during a scribe and break process while keeping conductive material out of an active display area of a display device that includes the encapsulation substrate 102. This is discussed further below with respect to FIGS. 8A and 8B.

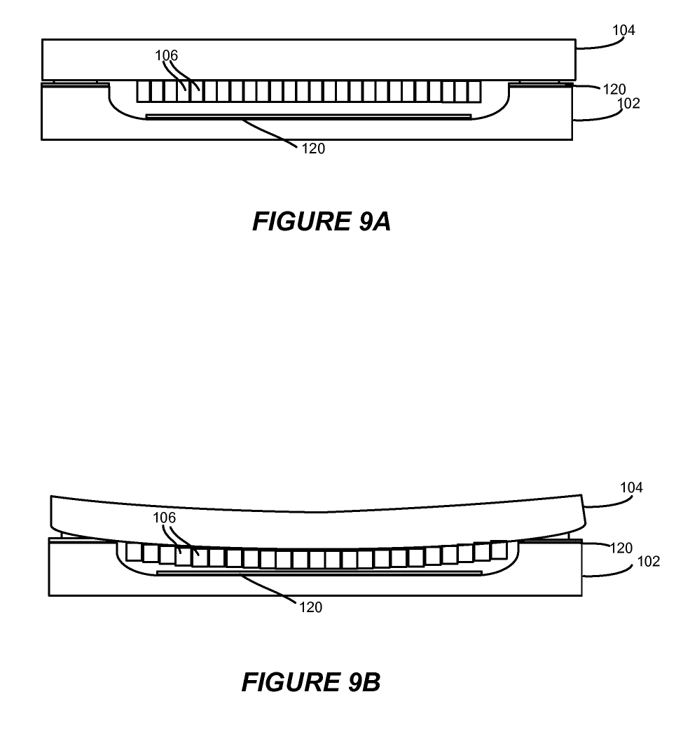

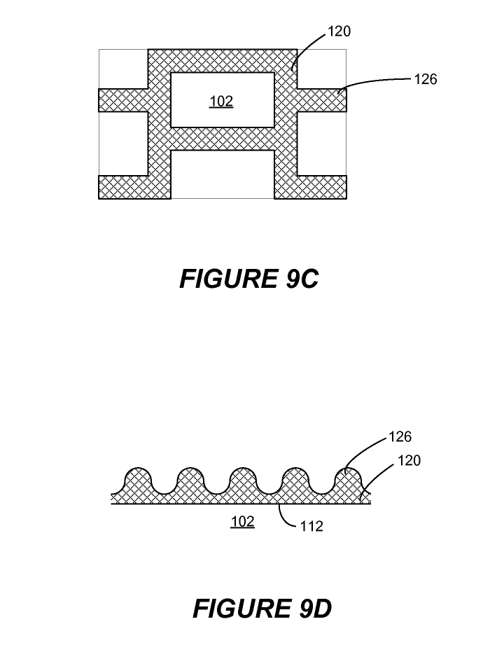

FIG. 5C shows an example of an encapsulation substrate 102 in which a conductive anti-static coating 120 is on a planar surface of a recess 108 and on a peripheral area 118 of the encapsulation substrate 102, but not on graded sidewalls 124 of the recess 108. The conductive anti-static coating 120 on the planar surface of the recess 108 may face display elements of a display device and may be the same or different material as the conductive anti-static coating 120 on the peripheral area 118. FIG. 5D shows an example in which a conductive anti-static coating 120 is within a recess 108 of an encapsulation substrate 102 and not on a peripheral area 118 of the encapsulation substrate 102. Implementations that include a conductive anti-static coating that face display elements may be used to mitigate damage due to ESD if the display elements contact the encapsulation glass as a result of shock, impact or user interaction. This is discussed further below with respect to FIGS. 9A and 9B.

In some implementations, one or both of the back side and the sidewalls of an encapsulation substrate of a device display device are coated with a conductive anti-static coating. FIG. 5E shows an example in which a front side 112, a back side 114, and sidewalls 116 of an encapsulation substrate 102 are coated with a conductive anti-static coating 120. In FIG. 5F, only sidewalls 116 of an encapsulation substrate 102 are coated with a conductive anti-static coating 120. FIG. 5G shows an example in which a back side 114 of an encapsulation substrate 102 is coated with a conductive anti-static coating 120. Implementations that include a conductive anti-static coating on sidewalls may mitigate damage due to ESD in handling. In some implementations, the sidewall coatings may provide a conductive pathway away from the front side of the encapsulation substrate to facilitate dissipation of the charge.

According to various implementations, a conductive anti-static coating may or may not be grounded. In some implementations, a conductive anti-static coating can be electrically connected to other conductive components of the display device. For example, a conductive anti-static coating can be in electrical communication with a conductive via (such as the conductive via 96 in FIG. 3B) that extends through an encapsulation substrate, metal routing on the surface of an encapsulation substrate, or metal routing on the surface of a transparent substrate. In some implementations, a conductive anti-static coating can be connected to a ground plane. In some implementations, a conductive anti-static coating may be electrically connected to a device, circuit, or other electrically active component on the transparent substrate through a metal seal that seals the encapsulation substrate to the transparent substrate.

While FIG. 4 and FIGS. 5A-5G provide examples of various arrangements of a conductive anti-static coating on an encapsulation substrate, other arrangements are possible. For example, a conductive anti-static coating may be on the back side and sidewalls, but not on the front side of an encapsulation substrate.

A conductive anti-static coating can be formed from any appropriate conductive material that is sufficiently conductive to dissipate built-up charge. The anti-static coating can be characterized in terms of sheet resistance. The sheet resistance of the material may depend on how much charge is to be dissipated; an anti-static coating configured to dissipate charge that may build up from larger surfaces rubbing together may have a fairly low sheet resistance. Charge that builds up over smaller surface areas may be dissipated with more resistive materials.

Generally, the anti-static coating material has a sheet resistance of less than 10⁶ ohms per square (Ω/sq). In some implementations, the conductive anti-static material may have a sheet resistance of between about 1 Ω/sq and 200 Ω/sq, or between about 40 Ω/sq and 200 Ω/sq. For example, the conductive anti-static coating may be a 500 Å ITO layer of having a sheet resistance of about 50 Ω/sq. More conductive materials, such as thin carbon or metal films having sheet resistances less than 1 Ω/sq may be used in some implementations. Further, in some implementations, anti-static coatings that are characterized as dissipative, rather than conductive, may be used. Dissipative materials are materials having sheet resistance of between 10⁶ Ω/sq to 10⁹ Ω/sq.

As indicated above, the anti-static coating may be transparent or opaque according to various implementations. In some implementations, transparency is not related to the display characteristics of the display device but facilitates alignment of a display glass or other transparent substrate to the encapsulation substrate. In some implementations, a transparent conductive anti-static coating can include a transparent conductive oxide (TCO). For example, the conductive anti-static coating can include indium tin oxide (ITO) and doped zinc oxides such as aluminum zinc oxide (AZO). In some implementations, a transparent conductive anti-static coating can include a transparent conductive polymer. For example, the conductive anti-static coating can include at least one of polyaniline, polypyrrole, a polythiophene such as poly (3,4-ethylenedioxythiophene), or any other inherently conductive or semiconductive polymer. In some implementations, a transparent conductive anti-static coating can include a transparent conductive ink. In some implementations, networks of conductive nanowire or nanotubes may be used. Examples of conductive nanostructures include silver nanowires and carbon nanotubes. An example of a silver nanowire-containing transparent conductive ink that may be used is ClearOhm from Cambrios Technologies.

The thickness of the TCO or other transparent conductive material used can depend on its conductivity and transparency. Conductivity and transparency of ITO and other transparent conductive materials are negatively correlated, with an increasing oxide in the ITO resulting in a more transparent, less conductive material. For a particular thickness, a TCO material may have a range of sheet resistances and transparencies depending on the relative amounts of its constituent components. Example thicknesses for TCO and other transparent conductive material are between about 50 Å and 500 Å. Thicknesses outside these ranges may be used depending on the sheet resistance of the material. In some implementations, because transparency is not used for display, a thinner, less transparent TCO film than would be used on a transparent substrate that functions as a display glass may be employed. For example, a TCO film that is less transparent and more conductive than a typical TCO film and having a thickness of between 30 Å and 300 Å may be used. In some implementations, a transparent conductive anti-static coating can include a metal film that is thin enough to be transparent for the purposes of alignment. For example, a thin metal film may be transparent such that an alignment mark on the encapsulation substrate can be read by an alignment laser or other alignment device. Examples of metals include aluminum, molybdenum, copper and the like. For example, an aluminum film between about 10 Å-200 Å may be used in some implementations to provide a coating that is both conductive and transparent. Thin conductive carbon-based films such as graphene or carbon paste films may be used. At small thicknesses, carbon-based films can be sufficiently transparent for alignment.

In implementations in which optical detection of alignment marks is not a concern, the conductive anti-static film may be opaque or transparent. Further, in implementations in which the front side of an encapsulation substrate is uncoated or only partially coated, alignment marks may be positioned on uncoated areas of the encapsulation substrate. In these implementations, the conductive anti-static film may be opaque or transparent.

As discussed further below with respect to FIGS. 9C and 9D, in some implementations, the conductive anti-static coating includes topographical features or inherent roughness to provide anti- stiction as well as anti-static properties. The topographical scale of these features may be as low as a few nanometers to hundreds of nanometers, for example. In some implementations, a conductive anti-static coating may include, for example, a conductive nanowire network on top of a TCO coating. The conductive nanowires are one example of topographic features that prevent or reduce stiction.

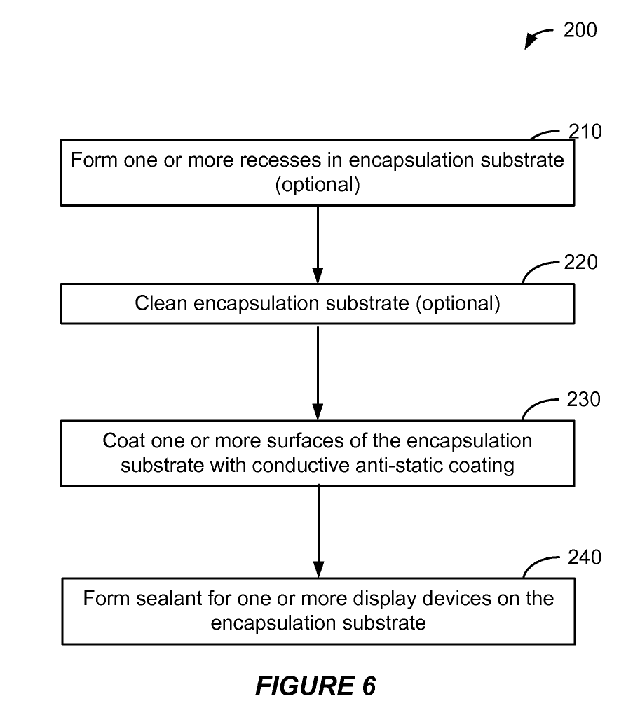

FIG. 6 shows an example of a flow diagram illustrating a manufacturing process for an encapsulation substrate having a conductive anti-static coating. Any of the operations of the manufacturing process may be performed at a wafer or panel level of a batch process at any appropriate point prior to singulation or on an individual package level after singulation.

The process 200 begins at block 210 with optionally forming one or more recesses in an encapsulation substrate. According to various implementations, block 210 may be performed at a panel or wafer level in which recesses for encapsulation substrates of multiple display devices are formed. Forming recesses can involve any appropriate process including, but not limited to, wet etching or sandblasting, or a combination of these techniques. For example, a glass encapsulation substrate may be etched using hydrogen fluoride based solutions. In implementations in which a planar encapsulation substrate is used, block 210 is not performed. In some implementations, a recess is formed to facilitate conformal coating of a conductive anti-static film in the recess. Such a recess may have non-vertical walls, such as the graded sidewalls 124 in the example of FIG. 4. The walls may sloped linear walls or curved walls according to various implementations. In implementations in which the coating is not formed on the sidewalls of the recess (such as in the example of FIG. 5C), the sidewalls may be vertical or near-vertical to facilitate selective coating on the planar portions of the encapsulation substrate.

The process 200 continues at block 220 with an optional clean of the surface on which the conductive anti-static film will be coated. Whether a clean is performed may depend on the method by which the one or more recesses are formed; for example, a sandblasted surface may have particles to be cleaned off prior to coating.

The process 200 continues at block 230 with coating one or more surfaces of the encapsulation substrate with a conductive anti-static coating. As discussed above with respect to FIGS. 5A-5G, one or more of the front side, the back side and the sidewalls may be coated. In coating a surface, all or a portion of the surface may be coated. For example, a ring of a conductive anti-static material may be patterned on a front side of an encapsulation substrate. In some implementations, block 230 may be performed prior to block 210. For example, to form a conductive anti-static coating on a peripheral area but not in the recess of a front side of an encapsulation substrate, the coating may be formed prior to forming the recess.

Any appropriate coating technique may be used including one or more of an electron beam coating process, a sputter deposition process or other physical vapor deposition (PVD) process, a vacuum coating process, a chemical vapor deposition (CVD) process, an atomic layer deposition (ALD) process, a solution-based coating process an evaporation process, an injection process, a dispensing process, a squeegee process, or a spin-coat process. The coating process may depend on the material to be coated and whether the coating is patterned or conformal. Conformal deposition of ITO or other TCO material may involve a vacuum deposition process, electron beam coating, or an evaporation process, for example. Formation of a patterned coating may involve screen printing, deposition on a lift-off mask, or the use of photoresist. In some implementations, the coatings can be formed by a maskless direct writing process, such as dispensing or inkjet printing. Conformal deposition of a thin metal film may involve a PVD, ALD or CVD process for example.

The coating technique may be determined in part by the amount of roughness in the conductive anti-static coating. Vapor deposition techniques tend to result in highly uniform thin films having less than 1 nm root mean squared (RMS) surface roughness, for example. Wet coating techniques such as spray coating of dispersions of particles provide films have higher roughness. For example, spray coating of 10 nm TCO particles may have roughness of about 10 nm. As such, a desired roughness can be produced by using appropriately-sized conductive nanoparticles. As discussed further below with respect to FIGS. 9C and 9D, in some implementations, a conductive anti-static coating having nanoscale or higher roughness may be used as an anti-stiction film.

The process 200 continues at block 240 with forming sealant for one or more display devices on the encapsulation substrate. This may involve, for example, dispensing an epoxy in one more sealing areas on the encapsulation substrate. For example, epoxy may be dispensed around each recess on the encapsulation substrate. In some implementations, a glass frit, metal sealing ring, or solder material may be formed.

As discussed above with respect to FIG. 4, block 240 may include forming the sealant on the conductive anti-static coating. For example, an epoxy may be dispensed on an ITO layer that covers the front side of an encapsulation substrate. In some implementations, conductive anti-static coating may provide more uniform surface properties, allowing the epoxy or other type of seal to adhere more readily than on a bare surface of the encapsulation substrate.

As indicated above, any of the operations of the manufacturing process may be performed at a wafer or panel level. Forming a coating on a front side or back side on an encapsulation substrate may be performed in one operation (or two operations for double sided coating) for encapsulation substrates for multiple display devices. However, forming a coating on sidewalls of an encapsulation device generally involves first singulating a wafer or panel level encapsulation substrate into individual units to make the sidewalls accessible.

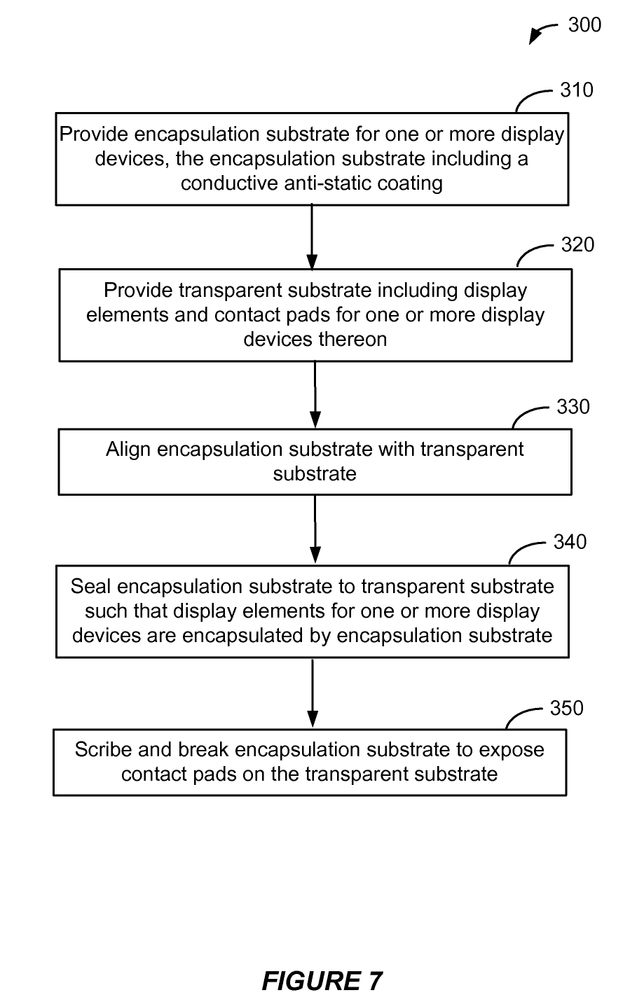

FIG. 7 shows an example of a flow diagram illustrating a manufacturing process for a display device having an encapsulation substrate including a conductive anti-static coating. The process 300 begins at block 310 by providing an encapsulation substrate for one or more display devices, with the encapsulation substrate including a conductive anti-static coating. Block 310 may involve providing an encapsulation substrate as described above with respect to FIG. 6, for example.

The process 300 continues at block 320 with providing a transparent substrate including display elements and contact pads for one or more displays thereon. The transparent substrate may additionally include TFTs on or otherwise associated with the display elements, metal routing lines, and other components for the display thereon. For example, a black mask for each display device may be on the transparent substrate.

The process 300 continues at block 330 with aligning the encapsulation substrate with the transparent substrate. As indicated above, in some implementations, this may involve the use of alignment marks on an encapsulation substrate, which transparent anti-conductive coatings can facilitate.

The process continues at block 340 with sealing the encapsulation substrate to the transparent substrate such that display elements for one or more display devices are encapsulated by the encapsulation substrate. Block 340 can involve one or more of applying pressure and exposing epoxy or other sealant material to heat or UV radiation to cure the material. The process 300 continues at block 350 with scribing and breaking the encapsulation substrate to expose contact pads on the transparent substrate. Standard scribing and breaking processes may be used. Further processing such as singulating the joined encapsulation and transparent substrates to form individual display devices may be performed. As discussed further below, in some implementations, the conductive anti-static coating mitigates an ESD event that may occur during processing such as at block 350.

FIGS. 8A and 8B show examples of schematic diagrams illustrating certain stages of manufacturing a display device having an encapsulation substrate including a conductive anti-static coating. FIG. 8A shows an example of a display device 100 including an encapsulation substrate 102 sealed to a transparent substrate 104 by a seal 110. Display elements 106 are disposed on the transparent substrate 104. Metal routing lines and contact pads 130 on the transparent substrate 104 provide electrical connection to the display elements 106. The encapsulation substrate 102 includes a conductive anti-static coating 120. A scribe line 132 indicates where the encapsulation substrate 102 is to be cut. FIG. 8B shows the display device 100 after breaking the encapsulation substrate 102 along the scribe line 132 in FIG. 8A. This exposes contact pads 130 on the transparent substrate 104, making them available for electrical connection. In some implementations, the conductive anti-static coating 120 mitigates ESD events that occur during one or both of the scribe and break operations. This may be useful for active-matrix displays in which TFTs may be damaged by unmitigated ESD events. In some implementations, the encapsulation substrate or display device may be exposed to an ion shower at various stages of the manufacturing processes illustrated in FIGS. 8A and 8B to facilitate charge dissipation.

In the example of FIGS. 8A and 8B, the conductive anti-static coating 120 does not extend into the recess of the encapsulation substrate 102. However, in some implementations, it may be useful to have a conformal and contiguous conductive anti-static coating that extends into the recess to facilitate charge dissipation. Examples of such conductive anti-static coatings are described above with respect to FIGS. 4 and 5E.

In some implementations, a conductive anti-static film may mitigate damage from ESD events due to display elements coming into contact with an encapsulation substrate. Such events can occur, for example, as a result of a mechanical shock to the display device from a drop, point contact load, etc. The potential for contact of display elements with an encapsulation substrate increases with display device size. As an example, a transparent substrate 104 may be 5-10 inches on the diagonal with the distance between display elements 106 and the encapsulation substrate 102 on the order of hundreds of microns. FIGS. 9A and 9B show examples of schematic diagrams illustrating a response of a display device to a mechanical shock. In FIG. 9A, a display device 100 includes an encapsulation substrate 102 and a transparent substrate 104. Display elements 106 are disposed on the transparent substrate 104. A conductive anti-static coating 120 is on the encapsulation substrate 102, including in a recess 108 that faces the display elements 106 on the transparent substrate 104. If the display device 100 is sufficiently large, a load on the transparent substrate 104 can result in the transparent substrate 104 flexing as illustrated in FIG. 9B. A point contact, a drop, or other load can result is a reduction of the distance between the display elements 106 and the encapsulation substrate 102. This decrease in distance can result in static discharge. The conductive anti-static coating 120 mitigates damage due to discharge. In the example of FIG. 9B, the conductive anti-static coating is not continuous from the recess to the peripheral region of the encapsulation substrate 102. In alternate implementations, the conductive anti-static coating may be contiguous and conformal as described above. This may help facilitate charge dissipation.

In some implementations, the conductive anti-static coating 120 has anti-stiction properties to reduce adhesion to the encapsulation substrate 102 and to mitigate damage due to contact and stiction. The topographic features may have heights at least an order of magnitude smaller than the display element size, and in some cases at least two orders of magnitude smaller than the display element size. For example, if an IMOD pixel size is tens of microns, the topographic features may have a height of no more than 1 micron or 100 nanometers.

FIGS. 9C and 9D show examples of schematic diagrams illustrating conductive anti-static films including topographic features. In FIG. 9C, a top view of a portion of a conductive anti-static coating 120 on an encapsulation substrate 102 is depicted. The conductive anti-static coating 120 is patterned such that it forms topographic features 126 that protrude from the surface of the encapsulation substrate 102. In FIG. 9D, a cross-sectional view of a portion of a conductive anti-static coating 120 is depicted. The conductive anti-static coating is not patterned, but includes topographic features 126. The topographic features 126 may be formed, for example, by patterning a deposited film, by using a deposition technique and material that includes nanoscale roughness, depositing a conformal conductive film on a layer (such as an insulating layer) that includes topographic features. In the examples of FIGS. 9C and 9D, the topographic features 126 are conductive. In alternate implementations, the topographic features may include conductive or insulating features on a continuous conductive anti-static coating.

According to various implementations, the topographical features 126 may have heights of at least 5 nm, at least 20 nm, or at least 100 nm. As discussed above, in some implementations, the topographic features 126 may be introduced by using a conductive anti-static coating that has a nanoscale RMS roughness. Examples include wet-coated solutions of TCO particles having diameters of between 5 and 20 nanometers and nanowire networks having diameters of between 5 and 100 nanometers. In some implementations, the topographic features may be introduced by patterning a conductive anti-static material on the encapsulation substrate. For example, a patterned graphene layer may be screen printed on the encapsulation substrate to form a conductive anti-static coating. The graphene or other patterned conductive material is spatially patterned such that electrical connectivity is maintained to dissipate static, but the potential contact area of display elements and the conductive anti-static film in the event of a mechanical shock is reduced. In another example, an insulating material may be patterned to form protrusions over or under which a continuous conductive anti-static film is coated.

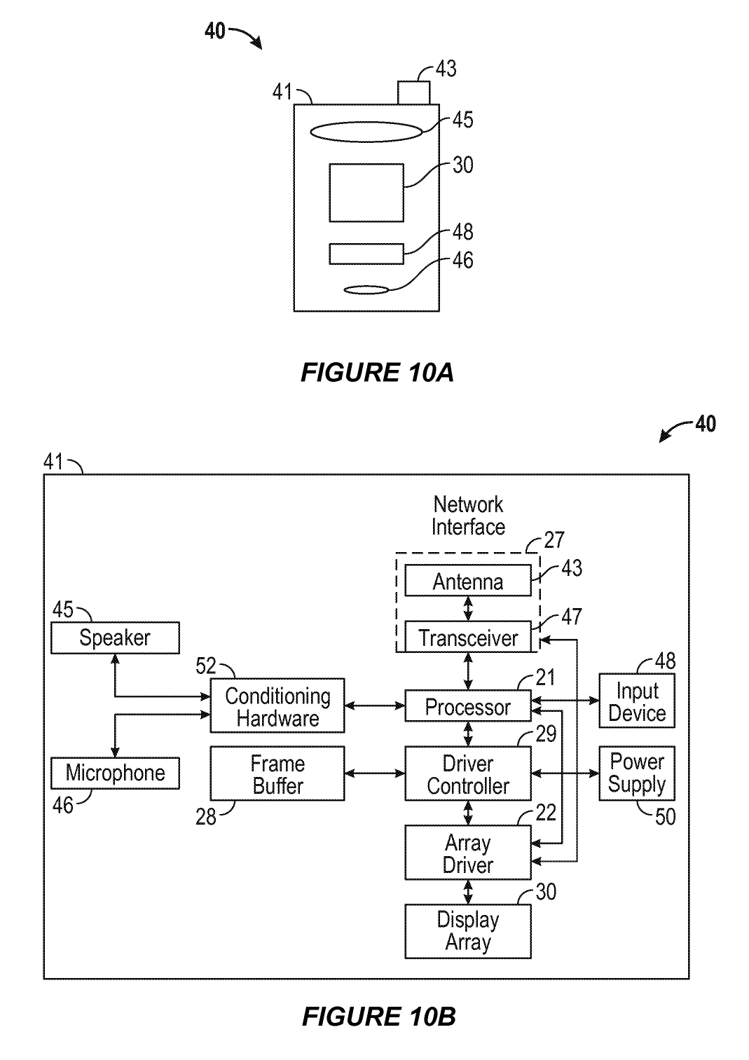

FIGS. 10A and 10B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 6A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 6A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display device comprising:
an encapsulation substrate;
a conductive anti-static coating on a least a portion of the encapsulation substrate;
a transparent substrate sealed to the encapsulation substrate by a seal; and
one or more display elements sealed between the transparent substrate and the encapsulation substrate, the one or more display elements configured to generate an image viewable through the transparent substrate, wherein the encapsulation substrate has a first side and a second side, the first side facing the display elements.

2. The display device of claim 1, wherein the conductive anti-static coating is disposed between the seal and the encapsulation substrate.

3. The display device of claim 1, wherein the seal is an epoxy seal.

4. The display device of claim 1, wherein the conductive anti-static coating is semi-transparent or transparent.

5. The display device of claim 1, wherein the conductive anti-static coating includes at least one of a transparent conducting oxide, a network of conductive nanostructures, a metal thin film, and a carbon-based thin film.

6. The display device of claim 1, wherein the display elements and the encapsulation substrate are spaced-apart by a gas or vacuum gap.

7. The display device of claim 1, wherein the display elements are electromechanical systems (EMS) display elements.

8. The display device of claim 1, wherein the display elements are interferometric modulator (IMOD) display elements.

9. The display device of claim 1, wherein the first side includes a recessed portion to accommodate the display elements and a peripheral portion that is sealed to the transparent substrate.

10. The display device of claim 9, wherein the conductive anti-static coating is on the peripheral portion of the first side of the encapsulation substrate.

11. The display device of claim 9, wherein the conductive anti-static coating is on the recessed portion of the first side of the encapsulation substrate.

12. The display device of claim 9, wherein the conductive anti-static coating is continuous across the peripheral portion and the recessed portion of the first side of the encapsulation substrate.

13. The display device of claim 1, wherein the conductive anti-static coating includes conductive topographic features, the conductive topographic features having a height of at least 5 nm.

14. The display device of claim 1, further comprising a processor that is configured to communicate with the display elements, the processor being configured to process image data; and a memory device that is configured to communicate with the processor.

15. The display device of claim 14, further comprising a driver circuit configured to send at least one signal to the display elements; and a controller configured to send at least a portion of the image data to the driver circuit.

16. The apparatus of claim 14, further comprising an image source module configured to send the image data to the processor, wherein the image source module comprises at least one of a receiver, transceiver, and transmitter.

17. The apparatus of claim 14, further comprising an input device configured to receive input data and to communicate the input data to the processor.

18. A display device comprising:
an encapsulation substrate;
a transparent substrate sealed to the encapsulation substrate by a seal;
one or more display elements sealed between the transparent substrate and the encapsulation substrate, the one or more display elements configured to generate an image viewable through the transparent substrate; and
a conductive anti-static coating on the encapsulation substrate, wherein the conductive anti-static coating faces the display elements and includes a plurality of conductive topographic features.

19. The display device of claim 18, wherein the conductive topographic features have a height of at least 5 nm.

20. The display device of claim 18, wherein the conductive topographic features have a height of at least 20 nm.

21. The display device of claim 18, wherein the conductive anti-static coating includes at least one of a transparent conducting oxide and a network of conductive nanostructures.

22. A method of manufacturing a display device, the method comprising:
coating one or more surfaces of an encapsulation substrate with a conductive anti-static coating; and
forming a sealant material on the encapsulation substrate including forming a sealant material on the conductive anti-static coating.

23. The method of claim 1, wherein a first side of the encapsulation substrate includes a recessed portion and a peripheral portion that surrounds the recessed portion, and wherein coating the one or more surfaces of the encapsulation substrates includes conformally coating the first side of the encapsulation substrate.

24. The method of claim 19, further comprising sealing the encapsulation substrate to a transparent substrate having one or more display elements disposed thereon such that the one or more display elements are encapsulated by the encapsulation substrate.

25. A display device comprising:
a transparent substrate having display elements thereon;
an encapsulation substrate sealed to the transparent substrate, thereby encapsulating the display elements; and
means for dissipating electrostatic discharge.

26. The display device of claim 25, wherein the means for dissipating electrostatic discharge include means for reducing stiction in the display device.
